(19) United States
(12) Patent Application Publication
(10) Pub. No.: US 2023/0365828 A1
(43) Pub. Date: Nov. 16, 2023

(54) BARRIER COATING WITH HIGH ASPECT RATIO PARTICLES

(71) Applicant: Sonoco Development, Inc., Hartsville, SC (US)

(72) Inventor: Richard Schwarz, Kyle, TX (US)

(21) Appl. No.: 17/741,944

(22) Filed: May 11, 2022

(51) Int. Cl. C09D 129/04; C09D 7/62; B65D 65/42

(52) U.S. Cl. CPC C09D 129/04; B65D 65/42; C09D 7/62; B65D 2565/387

(57) ABSTRACT

In an embodiment, the invention comprises a thermoformable sheet which comprises a polymer layer, and a barrier layer disposed adjacent the polymer layer. The barrier layer comprises a plurality of particles coated in an adhesion promotor. The plurality of coated particles are dispersed in a barrier solution of polyvinyl alcohol.

### FIELD OF THE INVENTION

The present invention relates generally to barrier coatings for polymeric materials. More particularly, the invention relates to improvements in barrier coatings for use in formable sheets and thermoformed containers.

### BACKGROUND

Barriers for laminates, formable sheets, and thermoformed containers typically comprise one or more substrates which prevent passage of moisture and/or gas through the laminate, sheet, or container. These substrates may include layers or coatings comprising foil or other metals or certain polymers having desired functional characteristics. The barriers may be coated, adhered to or extruded with one another and/or with the laminate or sheet. In layered barrier structures, each layer within the barrier may provide different a different type of barrier, which when used in combination, improve the overall barrier properties of the packaging.

Barrier layers may have broad variations in their inherent oxygen barrier characteristics and may be sensitive to variations in the application process. For example, metal foils may be easily scratched, impairing or destroying their barrier functionality. Polymers may be unevenly applied or unevenly stretched in the thermoforming process, for example, leading to weak spots within the barrier coating, again impairing or destroying the barrier functionality of the product.

The present inventors, through ingenuity and hard work, have developed food-contact packaging materials and structures which have a unique synergy, providing various advantages to the ultimate packaging structure, such as improved barrier qualities and/or improved consistency in barrier qualities upon thermoforming of a barrier-treated sheet. The inventive materials and packaging meet and exceed existing industry requirements for oxygen barrier, moisture barrier, hot fill capability of at least 180° F., trimability, oil resistance, acidic resistance, toughness requirements, and heat-sealing capability.

### BRIEF SUMMARY

In some embodiments of the present invention a high aspect ratio particle is added to a barrier material to increase the barrier properties through the packaging. Adding coated high aspect ratio particles into the barrier layer materials may improve the barrier characteristics of the barrier material, by creating a tortuous path through the material with impermeable particles. In some embodiments, the present invention uses gas impermeable particles such that oxygen or moisture cannot pass directly through the particles and must flow around the particles to penetrate the packaging. The coated particles may be used as a filler material in the barrier material such that less barrier material is used for the same thickness barrier layer. Thus, adding a high aspect ratio particle into a barrier layer will increase the favorable barrier characteristics of the material, while decreasing the amount of material used.

In an embodiment, the invention comprises a packaging structure which comprises a polymer layer and a barrier layer disposed adjacent the polymer layer. The barrier layer comprises a plurality of particles coated in an adhesion promoter, wherein the plurality of coated particles are dispersed in polyvinyl alcohol.

In an embodiment, the invention comprises a packaging structure which comprises a polymer layer having a cap layer disposed on either side of the polymer layer. A barrier layer is disposed adjacent one of the cap layers. In some embodiments, an overlacquer may be applied to the barrier layer.

In an embodiment, the invention comprises a packaging structure comprising a first structure defining a first polymer layer having a first barrier layer pattern applied to the first polymer layer and a second structure comprising a second polymer layer having a second barrier layer pattern applied to the second polymer layer. The first structure and the second structure joined by the first barrier layer and the second barrier layer.

In an embodiment, a thermoformable polymeric sheet is provided. The thermoformable polymeric sheet comprises a polymer layer and a barrier layer. The barrier layer is disposed adjacent the polymer layer. The barrier layer comprises a plurality of particles coated in an adhesion promoter. The plurality of coated particles are dispersed in a barrier solution.

In an embodiment, the plurality of particles may be inorganic. In an embodiment, the plurality of particles may define a high aspect ratio. In an embodiment the plurality of particles may be graphene, talc, or mica. In some embodiments, the plurality of particles may be impermeable, such as to create a tortuous path within the barrier layer.

In some embodiments the adhesion promoter may have a high cationic charge density and may be configured to reduce agglomeration of the plurality of particles. In some embodiments, the high cationic charge density causes the plurality of particles to repel each other. In some embodiments, the adhesion promoter is polyethylene imine, in other embodiments the adhesion promoter is polyurethane.

In some embodiments, the polymer layer may comprise a core layer, an external cap layer, and an internal cap layer. The external cap layer may be disposed on a first side of the core layer, and the internal cap layer may be disposed on a second side of the core layer. In some embodiments, the barrier layer may be adjacent the internal cap layer. In some embodiments, the external cap layer and the internal cap layer may comprise high density polyethylene. In some embodiments, the core layer may comprise post-consumer resin.

In some embodiments, the thermoformable polymeric sheet may comprise an overlacquer disposed on the barrier layer opposite the polymer layer. In some embodiments, the thermoformable polymeric sheet may comprise a second polymer layer disposed adjacent the barrier layer opposite the polymer layer. In some embodiments, the polymer layer and the second polymer layer may be polypropylene or amorphous polyethylene terephthalate. In some embodiments, the barrier layer may be a first barrier layer and a second barrier layer disposed between the polymer layer and the second polymer layer. In some embodiments, the barrier layer may not be coextensive with the polymer layer and the second polymer layer.

In some embodiments, the thermoformable polymeric sheet may comprise a stretch ratio between 2 and 5. In some embodiments, the plurality of coated particles may further be coated with polyvinyl alcohol. In some embodiments, the plurality of coated particles may be coated with an oxygen absorber, and/or ascorbic acid. In some embodiments, the barrier solution may be polyvinyl alcohol.

In another example embodiment a container may be formed from the thermoformable polymeric sheet.

In yet another example embodiment a method of making a barrier coating for a polymeric container is provided. The method comprises coating a plurality of inorganic particles with a cationic adhesion promoter and dispersing the plurality of coated particles in polyvinyl alcohol.

In yet another example embodiment a method of making a packaging structure is provided. The method comprises coating a plurality of particles with an adhesion promoter and dispersing the plurality of coated particles within polyvinyl alcohol to form a coating. The method continues by applying the coating to a polymer sheet, drying the coating, heating and stretching the coated polymer sheet into a packaging structure shape, and cooling the packaging structure.

In some embodiments, the coating may be applied to the polymer sheet by a Mayer rod or a gravure roll. In some embodiments, heating and stretching the coated polymer sheet comprises thermoforming.

In yet another example embodiment a method for making a formable sheet is provided. The method comprises coating a plurality of particles with an adhesion promoter within polyvinyl alcohol to form a coating, applying the coating to a polymer sheet, drying the coating, heating and stretching the coated polymer layer into a formable sheet, and cooling the formable sheet.

In yet another example embodiment a packaging structure is provided. The packaging structure comprises a polymer layer and a barrier layer disposed adjacent the polymer layer. The barrier layer comprises a plurality of particles coated in an adhesion promoter. The plurality of coated particles are dispersed in a barrier solution.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIGS. 1A-C illustrate cross-sectional views of a composition of a laminate comprising the inventive composition, in accordance with some embodiments of the present invention;

FIG. 2A illustrates an example particle, in accordance with some embodiments discussed herein;

FIG. 2B illustrates an example coated particle, in accordance with some embodiments discussed herein;

FIG. 2C illustrates the charges of the example coated particles shown in FIG. 2B, in accordance with some embodiments discussed herein;

FIG. 3A illustrates an example barrier layer comprising the coated particle shown in FIG. 2B, in accordance with some embodiments discussed herein;

FIG. 3B illustrates the example barrier layer shown in FIG. 3A after stretching, in accordance with some embodiments discussed herein;

FIG. 4 illustrates a cross-sectional view of an example container, in accordance with some embodiments discussed herein; and

FIG. 5 illustrates a flowchart of an example method of forming an example packaging structure comprising the inventive composition, in accordance with some embodiments discussed herein.

### DETAILED DESCRIPTION

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In an embodiment, the invention provides a barrier coating for polymer sheets and in particular for polymer sheets that will be thermoformed into containers. In an embodiment, the barrier coating comprises a barrier substance containing a dispersion of high aspect ratio particles or fillers which are coated with an adhesion promoting substance. The barrier coating is then applied to a polymer layer. In some embodiments, additional layers including polymer layers, overlacquers, and/or cap layers may be utilized with the barrier coating. In an embodiment, invention may comprise a formable sheet having certain barrier properties. In another embodiment, the formable sheet may be thermoformed or otherwise stretched or formed into packages or portion control containers, such as is common with yogurts, puddings, and dipping sauces.

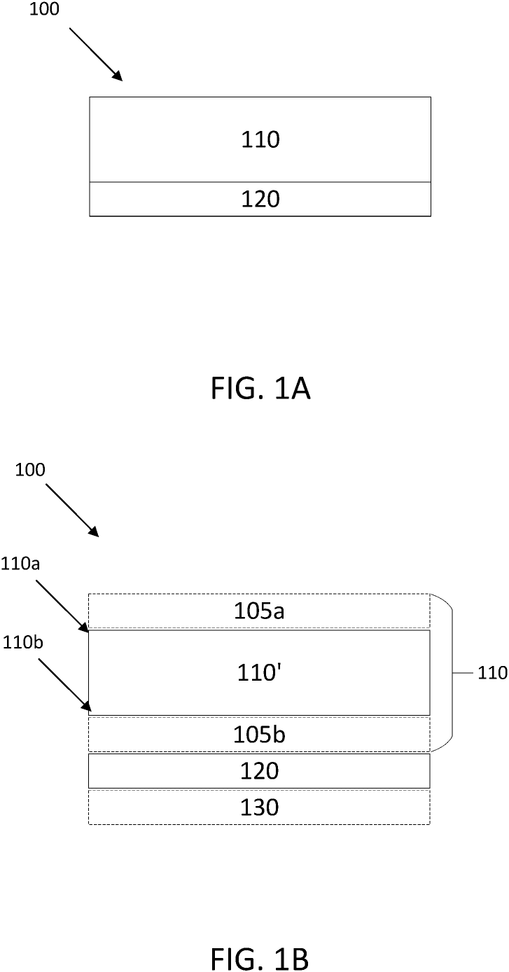

In an embodiment, the invention comprises a packaging structure or thermoformable polymeric sheet comprising multiple layers. In an embodiment, shown in FIG. 1A, a thermoformable polymeric sheet 100 may be formed with a polymer layer 110 and a barrier layer 120 disposed adjacent the polymer layer 110, each of which is described with more detail herein.

### The Polymer Layer(s)

In some embodiments, the polymer layer 110 may comprise a post-industrial resin or a post-consumer resin (PCR). In an embodiment, the polymer layer 110 comprises virgin polymer. In an embodiment, the polymer layer 110 comprises a combination of virgin polymer and PCR. In an embodiment, the polymer layer 110 comprises polyethylene terephthalate (PET). In an embodiment, the polymer layer 110 may comprise 100% PET. In an embodiment, the polymer layer 110 may comprise 100% polypropylene (PP). In an embodiment, the polymer layer 110 may comprise primarily PET with a high-density polyethylene (HDPE) component and a compatibilizer. In another embodiment, the polymer layer 110 comprises HDPE, polyethylene terephthalate (PET) or a PE/PET blend. In an embodiment the polymer layer 110 comprises amorphous polyethylene terephthalate (APET). In some embodiments, the polymer layer may comprise polystyrene, and/or polyacrylic. Any polymer known in the art may be utilized herein. In an embodiment, the polymer layer 110 may include an oxygen scavenger. In an embodiment, the polymer layer 110 may contain a color component.

In some embodiments, illustrated in FIG. 1B, the polymer layer 110 of the thermoformable polymeric sheet 100 may comprise one or more cap layers 105a, 105b on either side of a core layer 110′. In some embodiments, an external cap layer 105a may be disposed on a first side 110a of the core layer 110′, while in other embodiments, an internal cap layer 105b may be disposed on a second side 110b of the core layer 110′. In some embodiments, the cap layer 105 may be disposed between the core layer 110′ and the barrier layer 120. In an embodiment, the external cap layer 105a may comprise the food contact side of the resulting formable sheet or the packaging structure. The external cap layer 105a may comprise a food contact layer and a sealing layer for peelable film lidding.

In some embodiments, the cap layer 105a, 105b may comprise PCR and, optionally, a polyolefin. In an embodiment, the PCT in the cap layer 105a, 105b comprises virgin PCR. In an embodiment, the PCR in the cap layer 105a, 105b comprises high density polyethylene (HDPE). In an embodiment, the cap layer 105a, 105b may comprise 100% HDPE. In an embodiment, the cap layer 105a, 105b may comprise primarily HDPE with a minor PET component and a compatibilizer. In another embodiment, the PCR in the cap layer 105a, 105b comprises polyethylene (PE) or a PE/PET blend. In an embodiment, the cap layer 105a, 105b may include an oxygen scavenger. In an embodiment, the cap layer 105a, 105b may contain a color component.

In an embodiment, the thickness of the cap layer 105a, 105b may be between 2 and 5 mils. In another embodiment, the thickness of the cap layer 105a, 105b may be between 3 and 4 mils. In an embodiment, the thickness of the cap layer 105a, 105b may comprise between about 5% to about 20% of the thickness of the total thermoformable polymeric sheet 100 or container. In an embodiment, if the cap layer 105a, 105b is a blend of HDPE, PET, and compatibilizer, the HDPE is oriented to the outermost portion of the cap layer 105a, 105b, opposite the core layer 110′. In an embodiment, this orientation hides imperfections in the color of the regrind (i.e., recycled scrap from post-trim operations) from the view of the consumer.

In an embodiment, the total thickness of the thermoformable polymeric sheet 100 may be between 11 and 15 mils. In a particular embodiment, the total thickness of the thermoformable polymeric sheet 100 may be between 12 and 14 mils. In another embodiment, the total thickness of the thermoformable polymeric sheet 100 may be about 13 mils.

In an embodiment, at least one of the core layer 110′, and/or the cap layer 105a, 105b may comprise a coloring agent. Any coloring agent known in the art may be utilized.

Referring to FIG. 1C, in an embodiment, the thermoformable polymeric sheet 100 may comprise a plurality of polymer layers. In such embodiment, the thermoformable polymeric sheet 100 may comprise a first polymer layer 110a (as such polymer layer is described above), and a second polymer layer 110b. In some embodiments, the first polymer layer 110a and the second polymer layer 110b may comprise the same composition. In other embodiments, the first polymer layer 110a and the second polymer layer 110b may comprise different compositions. For example, in an embodiment the polymer layer may be primarily PET, and the second polymer layer may be primarily PP or vise versa.

In an embodiment, the first polymer layer 110a may be thinner than the second polymer layer 110b. In an embodiment, the first polymer layer 110a may be about half the thickness of the second polymer layer 110b. For example, in an embodiment, the thickness of the first polymer layer 110a may be between 1 and 6 mils, and the second polymer layer 110b may be between 2 and 12 mils. In another embodiment, the thickness of the first polymer layer 110a may be between 3 and 4 mils and the second polymer layer 110b may be between 6 and 8 mils. In an embodiment, the first polymer 110a and the second polymer 110b may be about the same thickness. For example, in an embodiment, the thickness of the first polymer 110a and the second polymer 110b may each be 6 mils.

In an embodiment, the second polymer layer 110b may be coated with, adhered to, or coextruded with a cap layer 105a. As with the above embodiments, in this embodiment, the cap layer 105a may represent the interior or food contact surface of the container or formable sheet. In addition, the cap layer 105a may be a sealing layer, which is designed to be heat-sealed to flexible film lidding, for example. In an embodiment, the cap layer 105a additionally allows for easy trim of the sheet or resulting tray, allows direct melt adhesion to the core layer and is a functional barrier to the migration of byproducts (which may form in the core layer during repeated reintroductions as regrind) into any food product contained within the ultimate container. In an embodiment, the cap layer 105a reduces splitting potential, meets the requisite color specifications, and reduces the necessary sealing temperature for film lidding.

### Barrier Layer

The barrier layer 120 described herein may comprise particles coated with an adhesion promoter and dispersed within a barrier solution, for example polyvinyl alcohol (PVOH), its copolymers vinyl acetate polyvinyl alcohol (VA-PVOH), and terpolymers PE-VA-PVOH. While PVOH and its derivatives are discussed herein as the barrier solution, it should be understood that any barrier solution known in the art may be utilized. As noted above, in an embodiment, the barrier layer 120 may be disposed (a) on an exterior (non-food-facing) surface of the packaging structure, adjacent the polymer layer 110, (b) adjacent a cap layer 105 (see FIG. 1B), or (c) between a first polymer layer 110a and second polymer layer 110b (see FIG. 1C).

In some embodiments, the barrier layer may comprise a plurality of particles dispersed throughout the layer. As will be discussed herein, the particles may be prepared to reduce coagulation between each of the particles and encourage distribution throughout the layer. For example, the particles may be prepared by coating them with adhesion promoters and/or dispersion promoters.

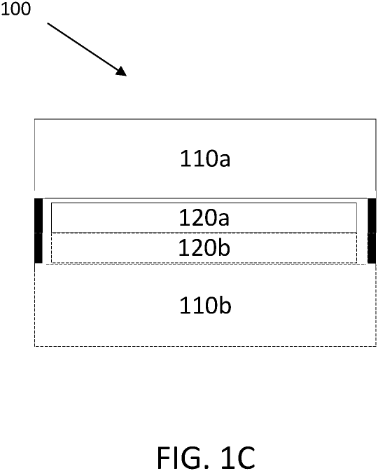

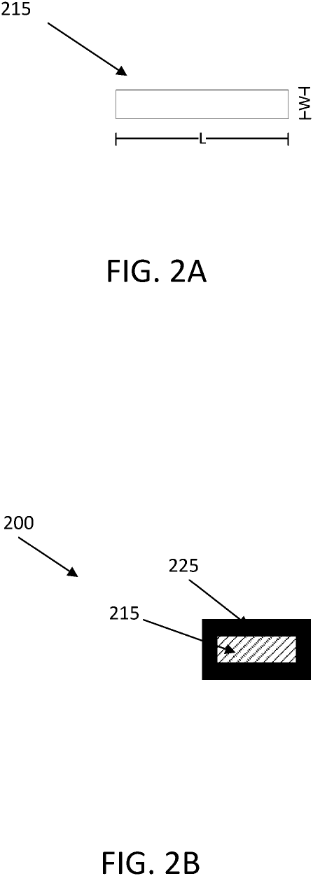

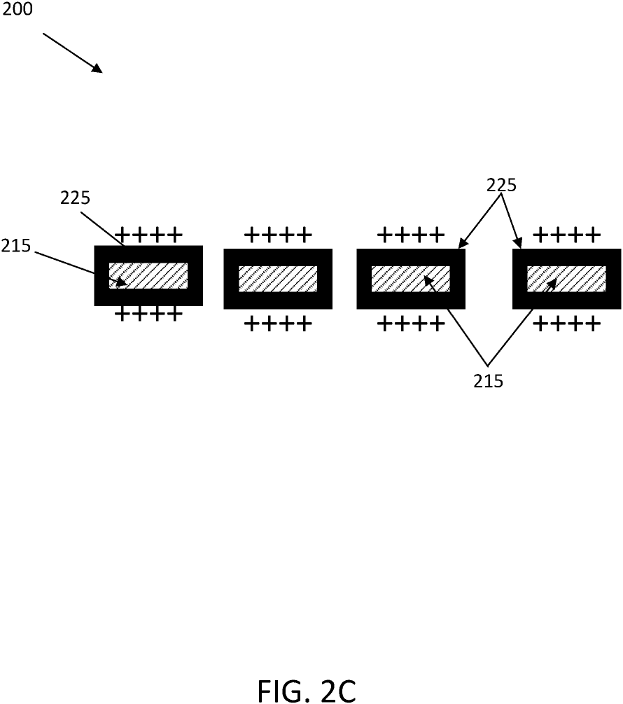

In some embodiments, as illustrated in FIG. 2A, a particle 215 may define an initial high aspect ratio between a length L (or any first dimension) and a width W (or any second dimension) of the particle 215; thus, the particles 215 may define a large surface area. In some embodiments, the ratio between the length and width of the particles may be in the range of 2:1 and 20:1. In other embodiments, the ratio between the length and width of the particles may be in the range of 2:1 and 10:1. In still other embodiments, the ratio between the length and width of the particles may be in the range of 2:1 and 5:1. In some embodiments, a soft particle 215 may break during dispersion and, thus, the aspect ratio may change.

In some embodiments, the particles 215 may be impermeable such that moisture, oxygen, and other fluids cannot pass through or into the particle 215. Thus, any contaminate, including moisture and oxygen, must travel around the particle 215 to reach the adjacent layer, nearer to the container, thereby creating a tortuous path. In some embodiments, the particles 215 may be organic compounds such as graphene, while in other embodiments, inorganic particles may be used, such as talc and/or mica. In some embodiments, the particles 215 may include glass, aluminum, plastics and nano-particles.

In some cases, the particles 215 dispersed within a barrier layer may conglomerate together, creating clumps, and potentially degrading the barrier properties of the layer due to weak points caused by the clumps.

To prevent such agglomeration of the particles 215, in one embodiment, the particles 215 may be coated with an adhesion promoter 225 to create a coated particle 200, as illustrated in FIG. 2B. The adhesion promoter 225 may be used to increase the bonding properties between the particles and the barrier solution, dispersion, or emulsion (i.e., PVOH). For example, polyethylene imine (PEI) may be utilized as an adhesion promoting coating for the particles. In other embodiments, polyurethane may be used as the adhesion promoting coating.

In some embodiments, the adhesion promotor 225 is a highly charged cationic adhesion promotor, as illustrated in FIG. 2C. The charge density of the adhesion promotor may reduce agglomeration of the coated particles in a solution or an emulsion by charge repulsion. In some embodiments, the adhesion promotor may cause the coated particles 200 to repel one another. Thus, the coated particles 200 may distribute throughout the solution, dispersion or emulsion, thereby preventing an agglomeration or coagulation of particles within the barrier layer.

In some embodiments, the particles 200 may be coated with the adhesion promoter 225 by intermixing and stirring a dilute aqueous solution of the adhesion promotor 225 and introducing the particles 215 into the solution. Mixing methods may comprise stirring the solutions together at room temperature, or slightly higher than room temperature, under low agitation. The solution may be dehydrated, thus yielding coated particles 200. In some embodiments, the coated particles 200 may be further coated with oxygen absorbers, for example ascorbic acid. If utilized, the oxygen absorber may absorb any oxygen which enters the barrier layer and be used as a surface area control.

In some embodiments, the particles 200 may be placed in a solution comprising water and the adhesion promoter 225. The solution may comprise at least 0.25% adhesion promoter, at least 3% adhesion promoter or at least 10% adhesion promoter. In some embodiments, the solution may comprise between 1-20% adhesion promoter, between 1-15% adhesion promoter or between 1-10% adhesion promoter. In some embodiments, the particles 200 may be placed into the adhesion promoter solution thereby forming a dispersion.

In some embodiments, the dispersion may be added to a PVOH solution. In some embodiments, the solubilized adhesion promoter in the particle dispersion within the barrier solution 230 may provide adhesion promotion for the PVOH to adhere to the polymer layer 110.

In an embodiment, the particle to coating ratio has the coating in a ratio of Particles:Adhesion Promoter of about 1:2 to about 1:10 by weight. In another embodiment, a combination of Particles and PEI may be used as the coating in a ratio of Particles:Adhesion Promoter of about 1:2 to about 1:5. In still other embodiments, the ratio of Particles:Adhesion Promoter may be about 1:4 or 1:5, depending on the sources of particle and PEI. In some embodiments, the ratio of Particles:Adhesion Promoter may be between 0.5:100 and 7:100, or between 1:100 and 2.5:100. In some embodiments, the particles to adhesion promotor ratio may be great enough to stabilize the particle dispersion within the solution.

In further embodiments, following coating with an adhesion promoter, the coated particles 200 may additionally be coated with PVOH, or a similar composition, to improve the dispersion of the coated particles 200 within the barrier solution 230 to form the barrier layer 120. For example, before being introduced into a PVOH barrier solution 230, a dilute solution of PVOH may be used to coat the coated particles 200. The PVOH-coated particles may then be at least partially dried. In some embodiments, the PVOH coating may have a different viscosity or concentration than the PVOH used within the barrier layer. Although PVOH is utilized as the example here, it should be understood that if a different barrier solution is utilized, the coated particles may receive a final coat of such barrier solution prior to being dispersed therein. In some embodiments, the coated 200 particles may be coated with stearic acid, or similar fatty acid.

In an embodiment, the coating has a ratio which is greater than or equal to about 0.5 part coated particles to about 1 parts PVOH (i.e. coated particles:PVOH of 1:4 or less), In some embodiments, the coating ratio may be up to 3 parts coated particle to 1 part PVOH. In some embodiments, the coating ratio may be made of equal parts coated particles and PVOH. In some embodiments, the coating ratio is weight based.

In an embodiment, the adhesion promotor and solution may define an adhesion promoter ratio. In some embodiments, the ratio between the adhesion promotor and the active PVOH may be between 1:100 and 30:100. In some embodiments, the ratio may be between 3:100 to 5:100 by weight.

As noted, the coated particles 200 may be dispersed within a barrier solution 230, for example a PVOH solution, to form a barrier coating. In some embodiments, the adhesion promoter 225 induces bonding between the particles 215 and the barrier solution. In some embodiments, a sonicator may be used to disperse the coated particles 200 throughout the barrier solution 230. The viscosity and concentration of the barrier solution 230 may be adjusted and optimized to minimize settling of the coated particles before application onto the polymer layer.

The barrier solution, comprising the coated particles 200 dispersed within the barrier solution 230 may be layered onto the polymer layer 110, in order to create the barrier layer 120. The barrier layer 120 may be applied via gravure system, Mayer rod (wire wound rod) system, sprayed, or extrusion coated in various embodiments. In an embodiment, the barrier layer 120 is flood coated, with 100% or near 100% coverage, onto the polymer layer 110. The barrier layer 120 may be continuous over the entire surface of the polymer layer 110. In an embodiment, partial or patterned coating application is avoided, but there may be applications wherein partial or patterned coating may be useful. For example, in an embodiment, the barrier layer 120 may be pattern applied such that a portion of each end of the width is free of the barrier layer 120 (see e.g., FIG. 1C).

In some embodiments, the thermoformable polymeric sheet 100 may comprise multiple barrier layers 120a, 120b. In some embodiments, a first barrier layer 120a may be applied to the first polymer layer 110a and a second barrier layer 120b may be applied to the second polymer layer 110b. After application of the respective barrier layers 120a, 120b onto the polymer layers 110a, 110b the barrier layers 120a, 120b may be brought into contact with one another and may be joined through thermal lamination or similar mechanisms.

In some embodiments, as illustrated in FIG. 1C, the barrier layers 120a, 120b may not be coextensive with the polymer layers 110, 110b. The polymer layers 110a, 110b, may have a greater affinity for one another than for the barrier layers 120a, 120b, therefor to promote a uniform thermoformable polymeric sheet 100 the barrier layer 120a, 120b may be applied to a portion of the polymer layers 110a, 110b, the polymer layers 110a and 110b extending beyond the barrier layer(s).

In such an embodiment, the barrier layer 120a, 120b may act as both a barrier layer and an adhesive layer between the first polymer layer 110a and the second polymer layer 110b. Use of the barrier layer 120 in this manner, between the polymer layers 110a, 110b, may actually improve the bond strength between the polymer layers. The final sheet/container may be cut with scissors with minimal delamination.

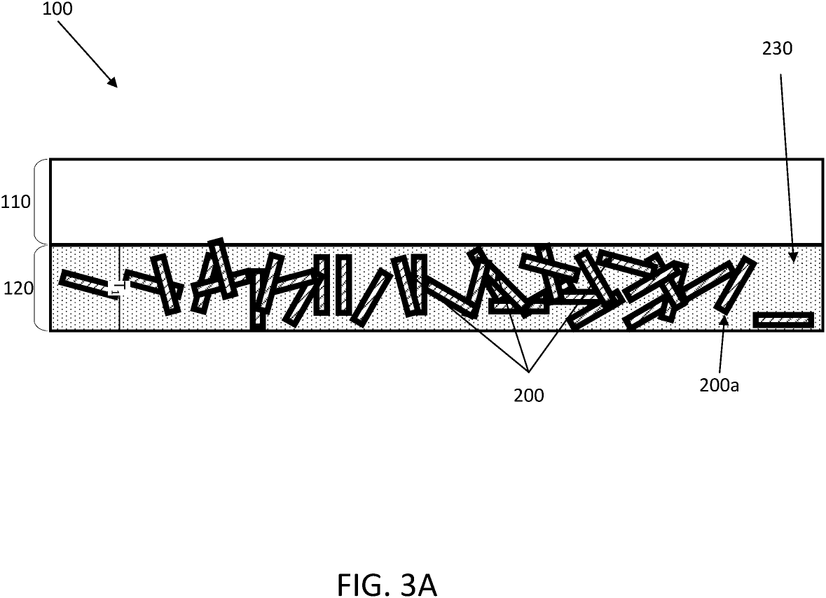

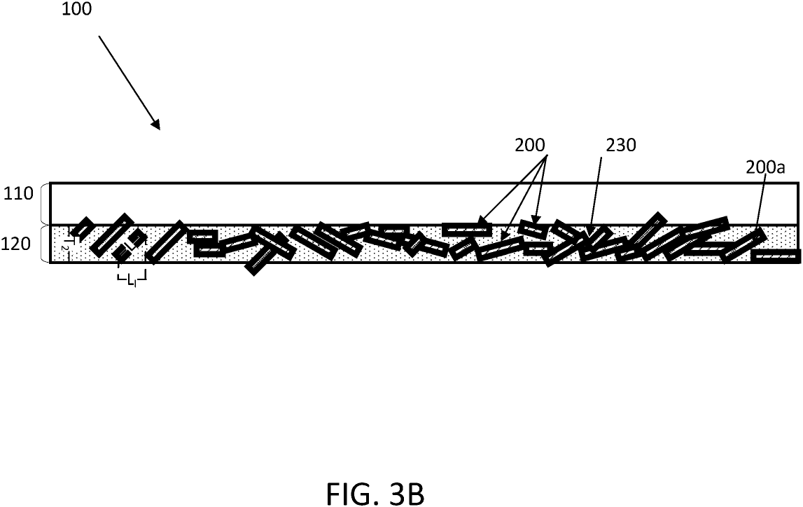

In an embodiment, the barrier layer 120 may be applied to a polymer layer 110 at a first thickness T₁ and stretched to a second thickness T₂ during thermoforming or similar (see e.g., T₁ of FIG. 3A, and T₂ of FIG. 3B). In some embodiments, the barrier layer 120 may have a first thickness of between about 0.1 and 4.0 µm. In an embodiment, the first thickness T₁ may be between about 0.1 and 3.5 µm. In an embodiment, the barrier layer 120 may have a first thickness T₁ of between about 0.1 and 3.0 µm. In an embodiment, the first thickness T₁ may be about 2.5 µm. In another embodiment, the first thickness T₁ of the barrier layer 120 may be about 0.5 µm.

In an embodiment, the applied barrier layer 120 thickness should account for a reduction in thickness upon drying. The barrier layer 120 may reduce in thickness by up to about 30% when dried. Thus, in an embodiment, the barrier layer 120 may be applied such that the thickness of the dried barrier layer 120 is between 1.0 and 5.0 µm. In another embodiment, the barrier layer 120 may be applied such that the thickness of the dried barrier layer 120 is between 2.0 and 4.0 µm. In yet another embodiment, the barrier layer 120 may be applied such that the thickness of the dried barrier layer is about 2.5 µm.

The barrier layer 120 may be compatible with thermoforming and may be configured to stretch within the thermoforming process, such that the polymer layer 110 remains covered with the barrier layer 120 layer after thermoforming. In some embodiments, the barrier layer 120 defines a stretch ratio of up to 5. In some embodiments, the barrier layer defines a stretch ratio of at least 2. In some embodiments, the stretch ratio between the first thickness T₁ and the second thickness T₂ is between 2 and 5 times. Thus, the barrier layer will extend from the first thickness T₁ to the second thickness T₂.

In some embodiments, the coated particles 200 may change orientation within the barrier layer 120 as the barrier layer 120 is applied, stretched, and/or formed into formable sheets and/or containers. In some embodiments, when the barrier layer 120 is stretched from the first thickness T₁ to the second thickness T₂ the coated particles 200 will rotate, rather than stretch, and favorably orient. For example, a coated particle 200a that is more vertical when applied may rotate, at least partially, upon stretching such that the coated particle 200a is at least partially diagonal within the barrier layer 120.

In an embodiment, the overlap and varied orientation of the coated particles 200 may create an impermeable portion within the barrier layer 120 as each of the particles is individually impermeable. For example, as illustrated in FIG. 3B, each of the coated particles 200 defines a length L. When the length L is parallel to the polymer layer 110, i.e., horizontal within the barrier layer 120, the coated particle creates an impermeable length L_{I} within the barrier layer 120. Similarly, when the coated particle is angled, i.e., not horizontal within the barrier layer 120, the coated particle defines an impermeable length L_{I} smaller than the length L of the coated particle 200. In some embodiments, the coated particles 200 may overlap when the barrier layer 120 is stretched, and the overlap between the coated particles 200 may yield an impermeable length L_{I} equal to the length of the laminate. Thus, as the coated particles 200 orient within the barrier layer 120 the coated particles reduce the effective permeable surface area of the thermoformed container.

In some embodiments, the coated particles 200 may enhance the crystallization within the PVOH, thereby improving the barrier properties of the PVOH. In some embodiments, the coated particles may increase and encourage nucleation within the PVOH.

In some embodiments, the length L of the particles 210 may be longer than the thickness T₁, of the application of the barrier layer 120. In some embodiments, the coated particles 200 may even be longer than or may traverse the barrier layer 120 and contact substrates on either side (i.e., polymer layer, cap layer, overlacquers, etc.). Surprisingly, due to the nature of the adhesion promotor, the coated particles 200 may encourage and improve the fixation of the polymer layers 110 to the barrier layer 120.

In some embodiments, the barrier layer 120 may be fully dried before thermoforming and/or before the application of additional layers. In some embodiments, the surface temperature of the barrier layer may be measured to ensure thorough drying. In some embodiments, the barrier layer 120 surface temperature is at least 90° C. to be considered dry. In some embodiments, when the surface is over 100° C., over 110° C., over 120° C. or over 130° C. the barrier layer 120 may be considered to be dry. In some embodiments, the barrier layer 120 may be dry when the surface temperature is between 100-110° C., or between 95-115° C. In some embodiments, the barrier layer 120 may be dry when the surface temperature of the barrier layer 120 is at least 110° C. The barrier layer 120 may be dried using any temperature/time combination known in the art. For example, the drying may be accomplished via a longer time period at a lower temperature, or at a higher temperature for a shorter time period. In any case, a dried barrier layer 120 should be free of tack and be suitable for rolling into a roll without any blocking/sticking which could prevent the unrolling of the roll.

In an embodiment, the invention may provide a formable sheet and thermoformed container with a more reliable oxygen barrier.

Crosslinking may also improve barrier properties of the coating and, in turn, the resulting sheet or container. Any other cross-linking methods could be utilized to crosslink the coated particles and PVOH, which may include, but is not limited to chemical, physical, or mechanical cross-linking. For example, electron beam crosslinking methodologies could be applied to crosslink the coated particles and PVOH within the adhesion promoter, optionally after the adhesion promotor coating has been applied and dried.

The inventors surprisingly discovered through this process that when dried, the adhesion promoter coated particles premixed with the barrier solution become a stretchable, formable gel (a thermoplastic elastomer) rather than a conventional thermoplastic, which melts and then solidifies in place in a fairly low energy state. Likewise, the gel form may contribute to favorable orientation of the particles and holding the particles in place during thermoforming processes.

### Overlacquer

In some embodiments, the thermoformable polymeric sheet 100 may optionally include an overlacquer 130. The overlacquer 130 (also referred to as an overcoat, overprint varnish, or “OPV”) described herein may be layered onto the thermoformable polymeric sheet 100 or container to create an outer coating configured to protect the barrier layer 120 from exposure to external forces. In this embodiment, the overlacquer 130 is applied to the barrier layer 120 once the barrier layer 120 is fully dried. In some embodiments, the barrier layer 120 and the overlacquer 130 may be applied with the same equipment, and in other embodiments, may be applied by separate equipment. One or more layers of overlacquer 130 may be applied as described herein.

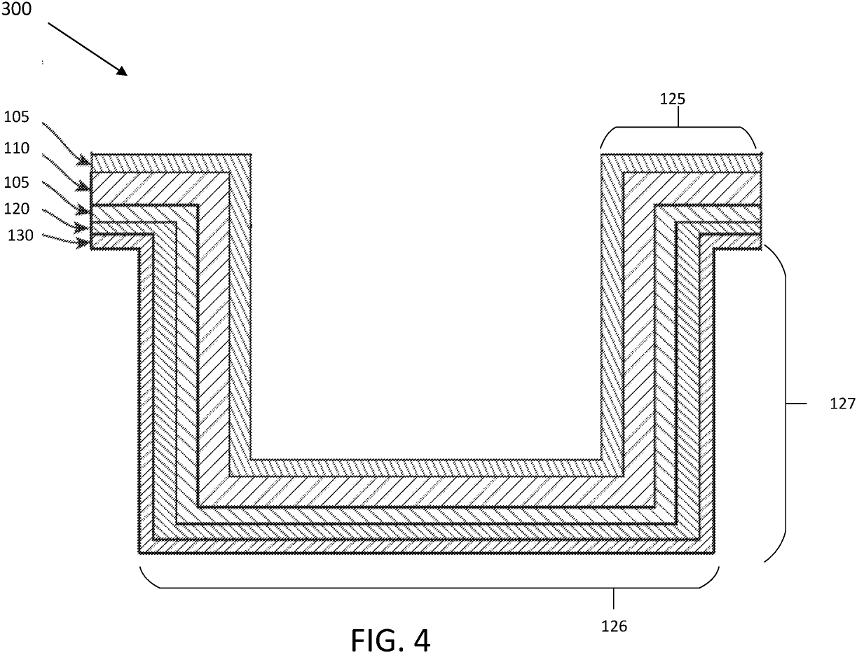

In some embodiments, the overlacquer 130 may be prepared with coated particles 200. The coated particles 200 may induce and improve bonding between the barrier layer 120 and the overlacquer 130. In some embodiments, adding coated particles 200 into the overlacuqer 130 may improve barrier qualities of the laminate and or container 300 (see e.g., FIG. 4).

The overlacquer 130 and the barrier layer 120 must be compatible when applied in thin coatings and thick coatings (e.g., thicknesses needed for thermoforming). The layers must not adversely interact with one another, as such interaction would compromise the product, and possibly the contents of the product.

In an embodiment, the overlacquer 130 completely coats the dry barrier layer 120 at a sufficient thickness to maintain the coverage after stretching. In some embodiments, undercoating may lead to exposure of the barrier layer 120 after stretching (e.g., thermoforming). Exposure of the barrier layer 120 may give the sheet product, or thermoformed product an unwanted tacky feel, and may induce the barrier layer 120 coating to transfer to a wet surface upon contact (e.g., hands, and/or counter tops). Use of an overlacquer 130 may not only improve the barrier durability but may also limit or eliminate any unwanted tacky feel or barrier transfer.

In some embodiments, the thickness of the overlacquer 130 is correlated to the chemical properties and grade of the selected overlacquer 130 and specifically the stretch properties during thermoforming. For example, an overlacquer with greater stretch properties will need a smaller thickness than an overlacquer with lesser stretch properties, as the overlacquer will be more adaptable. In some embodiments, the surface area of the overlacquer may be configured to stretch locally without cracking and/or removing, exposing, or uncovering the barrier layer 120. In some embodiments, the overlacquer may stretch up to 2.5 times the surface area, up to 3 times the surface area, up to 5 times the surface area, up to 7 times the surface area, and even up to 9 times the localized surface area and remain intact about the product.

In some embodiments, the overlacquer 130 may be applied to the barrier layer 120 with a thickness of up to 10 microns, up to 8 microns, up to 6 microns, up to 5 microns, or up to 3 microns. In an embodiment, the overlacquer 130 may be applied to the barrier layer 120 with a thickness of between 2 microns and 6 microns. In an embodiment, the overlacquer 130 may be applied to the barrier layer 120 with a thickness of between 3 microns and 5 microns. The thickness of the overlacquer 130 may reduce between 40-55% during drying, depending on the chemical properties thereof. In some embodiments, the thickness of the wet overlacquer will be approximately double that of the desired dried overlacquer thickness.

In some embodiments, the dried overlacquer 130 may have a thickness of at least 1 micron to maintain coverage of the barrier layer 120 during stretching and thermoforming. In some embodiments, the dried overlacquer may have a thickness of at least 2.5 microns, at least 3 microns, or at least 5 microns. In some embodiments, the dried thickness of the overlacquer 130 may be between 1.5 microns and 2.5 microns. In some embodiments, the dried thickness required may depend on the composition of the overlacquer. In some embodiments, the overlacquer may be applied such that after stretching, the overlacquer has a thickness of than 2.5 microns, at least 3 microns, or even at least 5 microns.

In some embodiments, the overlacquer 130 and/or barrier layer 120 may have varying thicknesses across each thermoformed container 100. For example, the thickness of the overlacquer 130 and/or the barrier layer 120 may be thicker along the flange 125 (see FIG. 4), than through the body 127 of the container, due to the stretching which occurs in the body 127 during thermoforming.

In some embodiments, the overlacquer 130 thickness may be balanced against drying inefficiency and cracking tendencies of dry and thicker overlacquers. In some embodiments, the overlacquer may define a maximum thickness determined by cracking when dry, and drying inefficiencies (e.g., not fully drying; tacky).

The overlacquer 130 may be fully dried before the formable sheet undergoes any forming process. When dried, the overlacquer 130 may be neutral to any forming process. The overlacquer 130 may be compatible with the recycle process, such that the sheet product remains recyclable in the normal stream.

In some embodiments, different overlacquer compositions may have different drying characteristics. In some embodiments, the overlacquer, and therefore the formable sheet may be dry, when the formable sheet is able to be rolled and/or stacked such that the overlacquer does not stick or attach to the cap layer of the sheet adjacent it.

Various overlacquers present different desirable qualities, and may be chosen to achieve various goals, and for compatibility for the various final products. In some embodiments, the overlacquer may be a water-based solution, suspension or dispersion, and in other embodiments, may be a water-based emulsion. In an embodiment, the OPV may avoid use of water solution stabilizers that can cause damage to the barrier layer or discoloration during forming. Overlacquers utilized herein may include: styrene - acrylic copolymers; acid olefin copolymers; acrylics; styrene-acrylic copolymers; vinyl acetate-ethylene VAE copolymers (optionally 90% VAE and 10%PE); ethylene-vinyl acetate (EVA) copolymers (optionally 10 to 40% VA and 60-90% PE); ethylene vinyl acetate copolymers with grafted maleic anhydride; polyethylene waxes (optionally as an additive to an OPV); and/or styrene-butadiene copolymers.

### FORMING AND FILLING

In some embodiments, systems, tooling, and methods are provided for manufacturing container 300, such as a single serving container, using a thermoforming process or similar. Generally speaking, a thermoforming device can be any device or mechanism that is used to form the formable sheet into a specific shape in a mold. A thermoforming device provides a shape transformation and in some cases the depth of the formed container exceeds the diameter of the formed container. The layers of the formable sheet experience stresses as they are stretched and formed and must be configured to withstand the thermoforming process.

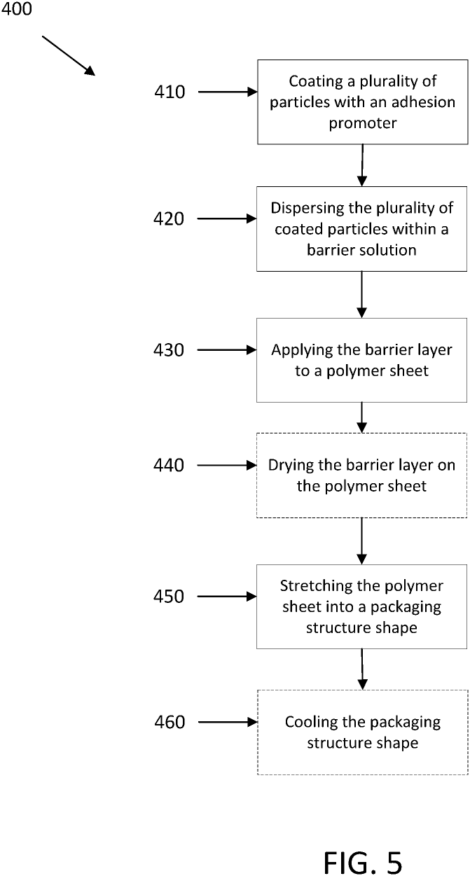

In an embodiment, the method of making a filled container 300, illustrated in FIG. 4 may comprise a variety of steps as illustrated in FIG. 5. At step 410, a plurality of particles may be coated with an adhesion promoter. At step 420 the plurality of coated particles may be dispersed within a barrier solution creating a barrier layer. At step 430 the barrier layer may be applied to a polymer sheet. Optionally, at step 440 the barrier layer may be dried on the polymer layer. At step 450, the polymer sheet including the barrier layer may be heated and stretched into a packaging structure shape. Optionally, at step 460 the packaging structure shape may be cooled.

In some embodiments, the polymer layer 110, and the coatings, for example the barrier layer 120, the cap layers 105a, 105b may all be recyclable throughout the manufacturing process, and after use.

In some embodiments, the body 127 walls of the container 300 may comprise more evenly oriented coated particles 200, since in the thermoforming process, the body walls 127 will stretch more than a bottom 126 of the container 300.

1. A thermoformable polymeric sheet comprising:
a polymer layer; and
a barrier layer disposed adjacent the polymer layer, wherein the barrier layer comprises a plurality of particles coated in an adhesion promoter, wherein the plurality of coated particles are dispersed in a barrier solution.

2. The thermoformable polymeric sheet of claim 1, wherein the plurality of particles are inorganic.

3. The thermoformable polymeric sheet of claim 1, wherein the plurality of particles define a high aspect ratio.

4. The thermoformable polymeric sheet of claim 1, wherein the plurality of particles are one of graphene, talc or mica.

5. The thermoformable polymeric sheet of claim 1, wherein the adhesion promoter has a high cationic charge density and is configured to reduce agglomeration of the plurality of particles.

6. The thermoformable polymeric sheet of claim 5, wherein the high cationic charge density causes the plurality of particles to repel each other.

7. The thermoformable polymeric sheet of claim 1, wherein the adhesion promoter is polyethylene imine.

8. The thermoformable polymeric sheet of claim 1, wherein the adhesion promoter is polyurethane.

9. The thermoformable polymeric sheet of claim 1, wherein the plurality of particles are impermeable, such as to create a tortuous path within the barrier layer.

10. The thermoformable polymeric sheet of claim 1, wherein the polymer layer comprises a core layer, an external cap layer disposed on a first side of the core, and an internal cap layer disposed on a second side of the core, wherein the barrier layer is adjacent the internal cap layer.

11. The thermoformable polymeric sheet of claim 10, further comprising an overlacquer disposed on the barrier layer opposite the polymer layer.

12. The thermoformable polymeric sheet of claim 10, wherein the external cap layer, and the internal cap layer comprise high density polyethylene.

13. The thermoformable polymeric sheet of claim 10, wherein the core layer comprises post-consumer resin.

14. The thermoformable polymeric sheet of claim 1, further comprising a second polymer layer disposed adjacent the barrier layer opposite the polymer layer.

15. The thermoformable polymeric sheet of claim 14, wherein polymer layer and the second polymer layer are polypropylene or amorphous polyethylene terephthalate.

16. The thermoformable polymeric sheet of claim 14, wherein the barrier layer is a first barrier layer and a second barrier layer disposed between the polymer layer and the second polymer layer.

17. The thermoformable polymeric sheet of claim 14, wherein the barrier layer is not coextensive with the polymer layer and the second polymer layer.

18. The thermoformable polymeric sheet of claim 1, wherein the thermoformable polymeric sheet comprises a stretch ratio between 2-5.

19. The thermoformable polymeric sheet of claim 1, wherein the plurality of coated particles are further coated with polyvinyl alcohol.

20. The thermoformable polymeric sheet of claim 1, wherein the plurality of coated particles are further coated with an oxygen absorber.

21. The thermoformable polymeric sheet of claim 1, wherein the coated particles are further coated with ascorbic acid.

22. The thermoformable polymeric sheet of claim 1, wherein the barrier solution is polyvinyl alcohol.

23. A container thermoformed from the thermoformable polymeric sheet of claim 1.

24. A method of making a barrier coating for a polymeric container, the method comprising:
coating a plurality of inorganic particles with a cationic adhesion promoter; and
dispersing the plurality of coated particles in polyvinyl alcohol.

25. A method of making a packaging structure, the method comprising:
coating a plurality of particles with an adhesion promoter;
dispersing the plurality of coated particles within polyvinyl alcohol to form a coating;
applying the coating to a polymer sheet;
drying the coating;
heating and stretching the coated polymer sheet into a packaging structure shape; and
cooling the packaging structure.

26. The method of claim 25, wherein the coating is applied to the polymer sheet by a Mayer rod or a gravure roll.

15. The thermoformable polymeric sheet of claim 14, wherein polymer layer and the second polymer layer are polypropylene or amorphous polyethylene terephthalate.

16. The thermoformable polymeric sheet of claim 14, wherein the barrier layer is a first barrier layer and a second barrier layer disposed between the polymer layer and the second polymer layer.

17. The thermoformable polymeric sheet of claim 14, wherein the barrier layer is not coextensive with the polymer layer and the second polymer layer.

18. The thermoformable polymeric sheet of claim 1, wherein the thermoformable polymeric sheet comprises a stretch ratio between 2-5.

19. The thermoformable polymeric sheet of claim 1, wherein the plurality of coated particles are further coated with polyvinyl alcohol.

20. The thermoformable polymeric sheet of claim 1, wherein the plurality of coated particles are further coated with an oxygen absorber.

21. The thermoformable polymeric sheet of claim 1, wherein the coated particles are further coated with ascorbic acid.

22. The thermoformable polymeric sheet of claim 1, wherein the barrier solution is polyvinyl alcohol.

23. A container thermoformed from the thermoformable polymeric sheet of claim 1.

24. A method of making a barrier coating for a polymeric container, the method comprising:
coating a plurality of inorganic particles with a cationic adhesion promoter; and
dispersing the plurality of coated particles in polyvinyl alcohol.

25. A method of making a packaging structure, the method comprising:
coating a plurality of particles with an adhesion promoter;
dispersing the plurality of coated particles within polyvinyl alcohol to form a coating;
applying the coating to a polymer sheet;
drying the coating;
heating and stretching the coated polymer sheet into a packaging structure shape; and
cooling the packaging structure.

26. The method of claim 25, wherein the coating is applied to the polymer sheet by a Mayer rod or a gravure roll.

27. The method of claim 25, wherein heating and stretching the coated polymer sheet comprises thermoforming.

28. A method of making a formable sheet, the method comprising:
coating a plurality of particles with an adhesion promoter within polyvinyl alcohol to form a coating;
applying the coating to a polymer sheet;
drying the coating;
heating and stretching the coated polymer layer into a formable sheet;
cooling the formable sheet.

29. A packing structure comprising:
a polymer layer; and
a barrier layer disposed adjacent the polymer layer, wherein the barrier layer comprises a plurality of particles coated in an adhesion promoter, wherein the plurality of coated particles are dispersed in a barrier solution.
